(19) United States
(12) Patent Application Publication
(10) Pub. No.: US 2025/0121402 A1
(43) Pub. Date: Apr. 17, 2025

(54) ENHANCED ROBOTICALLY INTEGRATED THERMAL SPRAY

(71) Applicant: GE Infrastructure Technology LLC, Greenville, SC (US)

(72) Inventors: Lawrence M. LEVY, Greenville, SC (US); Christopher LOCHNER, Greenville, SC (US); Gabriel SEPPALA, Greenville, SC (US)

(73) Assignee: GE Infrastructure Technology LLC, Greenville, SC (US)

(21) Appl. No.: 18/485,526

(22) Filed: Oct. 12, 2023

(51) Int. Cl. B05C 11/10; B05C 13/00

(52) U.S. Cl. CPC B05C 11/1005; B05C 13/00

(57) ABSTRACT

A table or system for assessing the coating of parts may include loading platforms on which parts are placed; load cells connected to the loading platforms and configured to detect weights of the parts on the loading platforms; and memory coupled to processing circuitry, wherein the processing circuitry configured to: select a coating program to be applied to a part placed on a first loading platform of the loading platforms; determine a pre-coating weight of the part on the first loading platform; determine a post-coating weight of the part on the first loading platform; and determine a difference between the pre-coating weight and the post-coating weight.

### TECHNICAL FIELD

This disclosure generally relates to a table and system for thermal spray processes.

### BACKGROUND

In a variety of applications, a coating can be applied to one or more surfaces of a component to protect it from the combined effects of high temperatures and oxidizing environment. Some surfaces may allow only one part at a time to be sprayed while on the surface, and only allow for loading and unloading one part at a time. Some surfaces also do not allow instant feedback regarding the quantity of coating applied to the part, and may not prevent operator error in selecting the wrong coating program.

### SUMMARY

A table for assessing a coating of parts may include: loading platforms on which parts are placed; load cells connected to the loading platforms and configured to detect weights of the parts on the loading platforms; and memory coupled to processing circuitry to: select a coating program to be applied to a part placed on a first loading platform of the loading platforms; determine a pre-coating weight of the part on the first loading platform; determine a post-coating weight of the part on the first loading platform; and determine a difference between the pre-coating weight and the post-coating weight.

A table for assessing a coating of parts may include: loading platforms on which parts are placed; load cells connected to the loading platforms and configured to detect weights of the parts on the loading platforms; wheels; a docking assembly configured to secure the table; and memory coupled to processing circuitry to: select a coating program to be applied to a part placed on a first loading platform of the loading platforms; determine a pre-coating weight of the part on the first loading platform; determine a post-coating weight of the part on the first loading platform; and determine a difference between the pre-coating weight and the post-coating weight.

A system for assessing a coating of parts may include: loading platforms on which parts are placed; load cells connected to the loading platforms and configured to detect weights of the parts on the loading platforms; an electrical output; and memory coupled to processing circuitry to: select a coating program to be applied to a part placed on a first loading platform of the loading platforms; determine a pre-coating weight of the part on the first loading platform; determine a post-coating weight of the part on the first loading platform; and determine a difference between the pre-coating weight and the post-coating weight, wherein the electrical output is configured to output electrical signals indicative of the coating program and the difference.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a front perspective view of a thermal spray system in accordance with one embodiment of the present disclosure.

FIG. 2 is a perspective view of a loading platform and load cell of the thermal spray system of FIG. 1 in accordance with one embodiment of the present disclosure.

FIG. 3 is a perspective view of the load cell of FIG. 2 in accordance with one embodiment of the present disclosure.

FIG. 4 is a rear perspective view of the table of the thermal spray system of FIG. 1 in accordance with one embodiment of the present disclosure.

FIG. 5 is a front view of the table of the thermal spray system of FIG. 1 in accordance with one embodiment of the present disclosure.

FIG. 6 is a side view of the table of the thermal spray system of FIG. 1 in accordance with one embodiment of the present disclosure.

FIG. 7 is a rear perspective view of the table of the thermal spray system of FIG. 1 in accordance with one embodiment of the present disclosure.

FIG. 8A is a perspective view of a portion of the docking assembly of FIG. 6 of FIG. 1 in accordance with one embodiment of the present disclosure.

FIG. 8B is a perspective view of a portion of the docking assembly of FIG. 6 of FIG. 1 in accordance with one embodiment of the present disclosure.

FIG. 9 is a perspective view of a portion of the system of FIG. 1 for setting the table in accordance with one embodiment of the present disclosure.

FIG. 10 is a cross-section view of the portion of FIG. 9 in accordance with one embodiment of the present disclosure.

FIG. 11 is a perspective view of the docking assembly of FIG. 6 for docking the table of the system of FIG. 1 in accordance with one embodiment of the present disclosure.

FIG. 12 is a side view of the docking device of FIG. 11 in accordance with one embodiment of the present disclosure.

FIG. 13 is a flow diagram for a process of coating parts using the system of FIG. 1 in accordance with one embodiment of the present disclosure.

FIG. 14 is a block diagram of an example machine upon which any of one or more techniques (e.g., methods) may be performed in accordance with one or more example embodiments of the present disclosure.

Certain implementations will now be described more fully below with reference to the accompanying drawings, in which various implementations and/or aspects are shown. However, various aspects may be implemented in many different forms and should not be construed as limited to the implementations set forth herein; rather, these implementations are provided so that this disclosure will be thorough and complete, and will fully convey the scope of the disclosure to those skilled in the art. Like numbers in the figures refer to like elements throughout. Hence, if a feature is used across several drawings, the number used to identify the feature in the drawing where the feature first appeared will be used in later drawings.

### DETAILED DESCRIPTION

In a variety of applications, a coating can be applied to one or more surfaces of a component to protect it from the combined effects of high temperatures and oxidizing environment. In any coating process, it is essential to achieve correctly designed coating thickness. At least for this reason, it is important to run the correct coating program for a robotically controlled thermal coating process. Ensuring that the correct coating thickness is applied to a part may depend on feedback indicating whether the set point thickness has been achieved, which may be determined based on a change in weight from before and after the coating.

In one or more embodiments, to ensure proper thermal coating and to increase thermal coating efficiency, a table may include multiple (e.g., at least two, six or twelve) load cells with which to interface with a thermal spray robot, allowing for multiple parts to be concurrently loaded onto the table, sprayed, cooled and concurrently unloaded off the table. The load cells of the table may be used to determine the weight of the parts, and based on the weight of the parts, processing circuitry of the table may determine which part has been loaded onto the table. Based on the identified part on the table, the processing circuitry may select a coating program to run. The coating program may control a thermal spray robot that sprays the coating onto the parts on the table. The load cells may provide feedback regarding the weight of the parts before and after the coating is applied. The change in weight due to the coating may indicate the coating thickness, and coating may be reapplied until the set point thickness is achieved. In this manner, the table may interface with the spraying robot to ensure that the correct spraying program is used for the given parts, and that the desired coating thickness is applied.

In one or more embodiments, the table may be moveable, but able to be precisely located inside a coating cell by way of conical datum pads, for example, on the bottom of the table. The pads may be used to raise the table off the ground and into a stable position prior to the coating process. The table also may include a universal dock on the loading stations to be able to accommodate multiple fixtures and components. The dock may allow for many different components to be able to be loaded and sprayed without relying on a human operator to select the spraying program.

In one or more embodiments, the load cells of the table may provide nearly instant feedback to processing circuitry of the table regarding the quantity of the coating applied to the parts on the table. By providing this feedback based on the weight of the parts, the table avoids the need for the parts to be removed from the table and evaluated for coating thickness.

The above descriptions are for purposes of illustration and are not meant to be limiting. Numerous other examples, configurations, processes, etc., may exist, some of which are described in greater detail below. Example embodiments will now be described with reference to the accompanying figures.

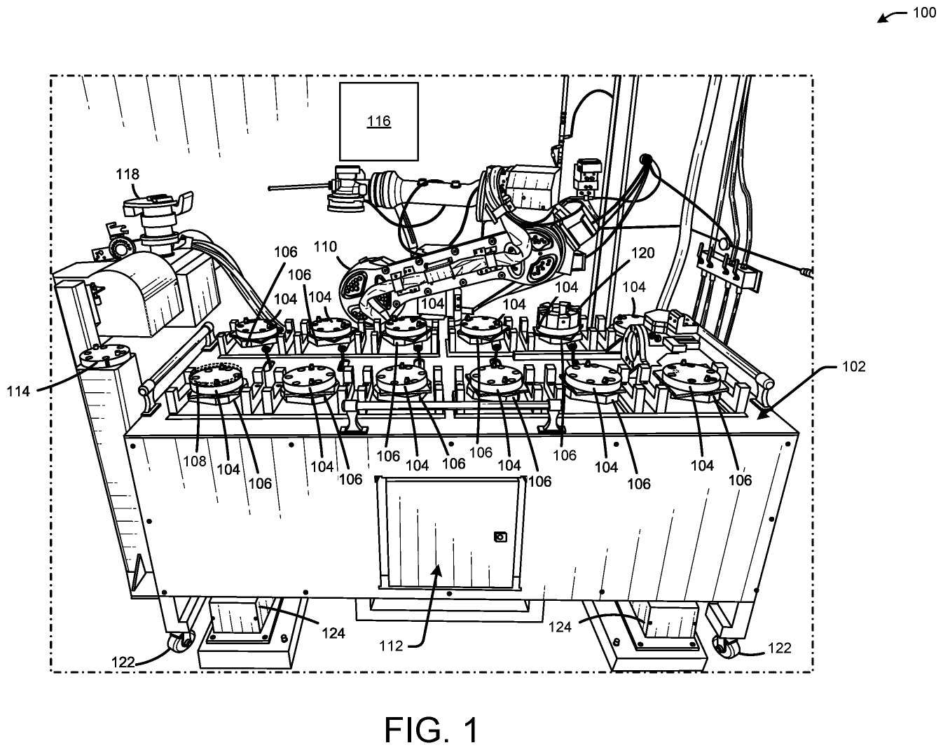

FIG. 1 is a front perspective view of a thermal spray system 100 in accordance with one embodiment of the present disclosure.

Referring to FIG. 1, the thermal spray system 100 may include a table 102 with multiple loading platforms 104 (e.g., pedestals) positioned on load cells 106. A part 108 (e.g., to be coated in a coating process) may be placed (e.g., by a robot 110) on a loading platform 104, and the load cell 106 may sense the weight of the part 108 both before and after coating of the part. The table 102 may include twelve (or another number) loading platforms 104 and load cells 106. The table 102 may include an electronic dock 112 with processing circuitry that may receive signals and voltages from the load cells 106 (e.g., from cables connecting the load cells 106 to the processing circuitry), and may interpret the signals and voltages to determine the weight of the part 108.

Still referring to FIG. 1, the thermal spray system 100 may include an additional loading platform 114, which may be used as a cooling station for the part 108 after the part has been heated by a furnace 116. For example, the robot 110 may place the part 108 on a loading platform 104 for a pre-coating weight. Based on the pre-coating weight of the part 108, the processing circuitry of the electronic dock 112 may identify the part 108 and select a coating program for the part 108. After the pre-coating weight, the robot 110 may engage the part 108, remove the part 108 from the table 102, and place the part 108 into the furnace 116 for pre-heating. After the part 108 is pre-heated by the furnace 116, the robot 110 may place the part on a coating station 118, where the part 108 may be coated. After coating, the robot 110 may engage the part 108 and place the part 108 back onto a loading platform 104 for determining the post-coating weight (e.g., allowing for a determination of the difference in pre-coating and post-coating weights, indicative of the coating mass). A gripping system 120 may be used by the robot 110 to grip or otherwise engage the part 108. The table 102 also may include wheels 122 (or bearings, a rail system, etc.) and moveable components 124 allowing the table 102 to be set into a position and to be lifted.

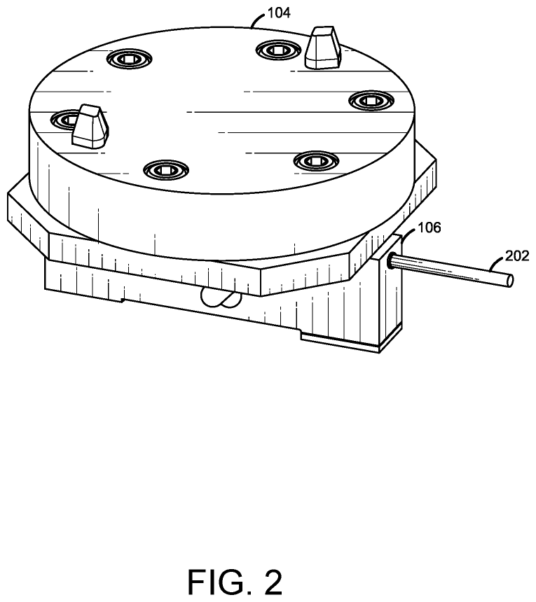

FIG. 2 is a perspective view of a loading platform 104 and load cell 106 of the thermal spray system 100 of FIG. 1 in accordance with one embodiment of the present disclosure.

Referring to FIG. 2, the loading platform 104 may be an air cylindrical tie rod with air actuation (e.g., air extension and retraction). Cables 202 may connect to the load cell 106 and may connect to the processing circuitry of the electronic dock 112 of FIG. 1. The cables 202 may include positive and negative measuring signals, positive and negative excitation voltages, and positive and negative sense leads. The cables 202 may carry the signals/voltages from the load cell 106 to the processing circuitry. By positioning the load cell 106 underneath the loading platform 104, when the part 108 is placed on the loading platform 104 as shown in FIG. 1, actuation of the loading platform 104 may exert a force onto the load cell 106.

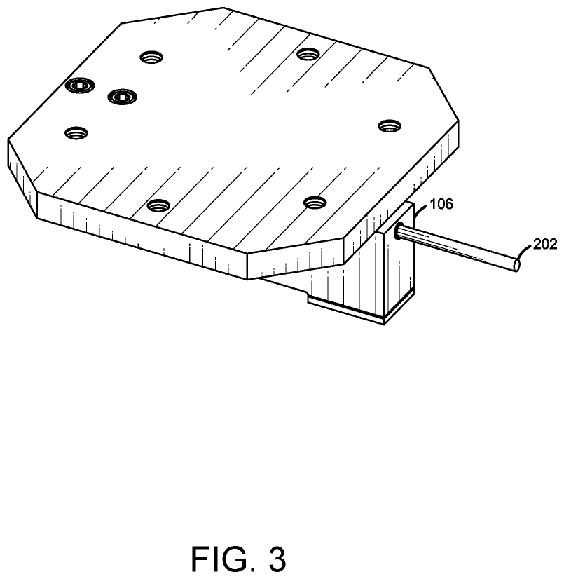

FIG. 3 is a perspective view of the load cell 106 of FIG. 2 in accordance with one embodiment of the present disclosure.

In FIG. 3, the loading platform 104 is not shown, allowing for a more complete view of the load cell 106 and how it may attach to the loading platform 104.

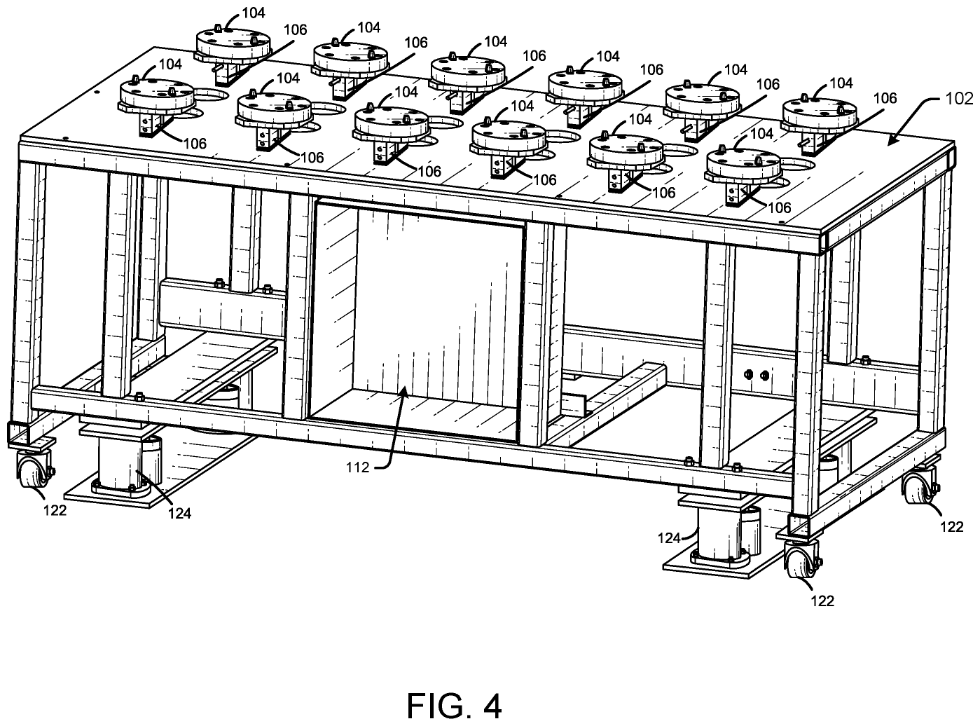

FIG. 4 is a rear perspective view of the table of the thermal spray system of FIG. 1 in accordance with one embodiment of the present disclosure.

Referring to FIG. 4, the table 102 may include twelve loading platforms 104 and twelve load cells 106. Alternatively, the table 102 may include two or more loading platforms 104 and two or more load cells 106, or six or more loading platforms 104 and six or more load cells 106. The wheels 122 are shown on both sides and on the front and back of the table 102 in FIG. 4.

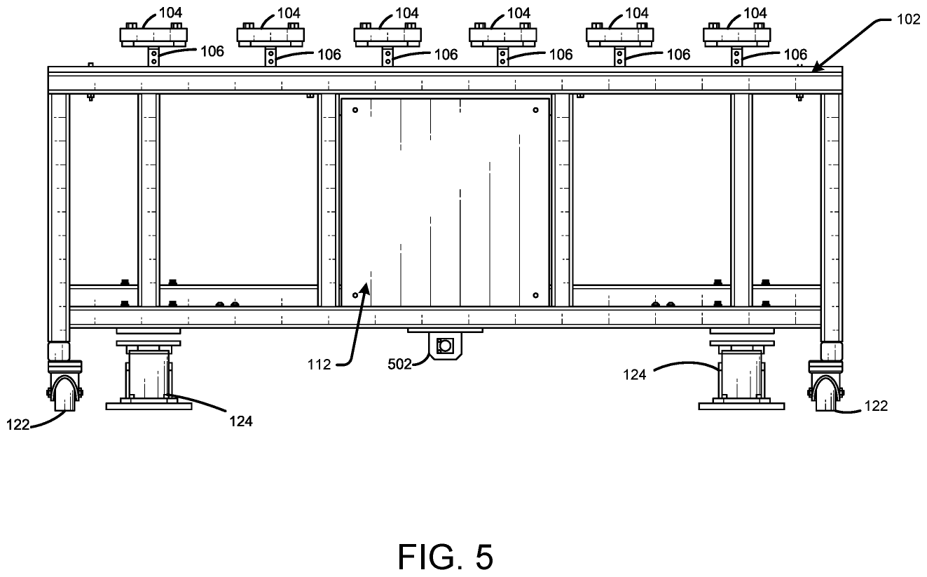

FIG. 5 is a front view of the table 102 of the thermal spray system 100 of FIG. 1 in accordance with one embodiment of the present disclosure.

In FIG. 5, only six of the loading platforms 104 and the load cells 106 are shown because the loading platforms 104 and the load cells 106 may be arranged in rows (e.g., two rows of six as shown). Also shown in FIG. 5 is an electrical output 502 for the table 102. The electrical output 502 may output electrical signals from the processing circuitry of the electronic dock 112. For example, the electrical output 502 may output the pre-coating and post-coating weights of a part 108, and/or any decisions about the coating process for the part based on the difference in the pre-coating and post-coating weights. For example, for a given part and its corresponding coating program, the difference in mass represented by the pre-coating weight and the post-coating weight may be known by the processing circuitry. In this manner, the processing circuitry may determine whether the coating process of a part operated properly and resulted in the correct amount of coating applied to the part. The electrical output 502 may output signals indicating whether the proper coating mass was applied or not, along with recommendations for additional coating and/or adjustments to the coating process/equipment. The signals output by the electrical output 502 may be wireless and/or wired.

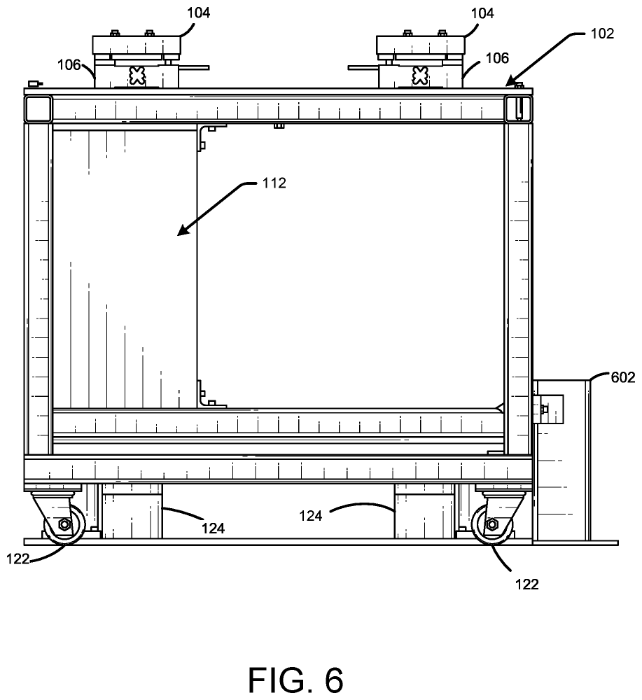

FIG. 6 is a side view of the table 102 of the thermal spray system 100 of FIG. 1 in accordance with one embodiment of the present disclosure.

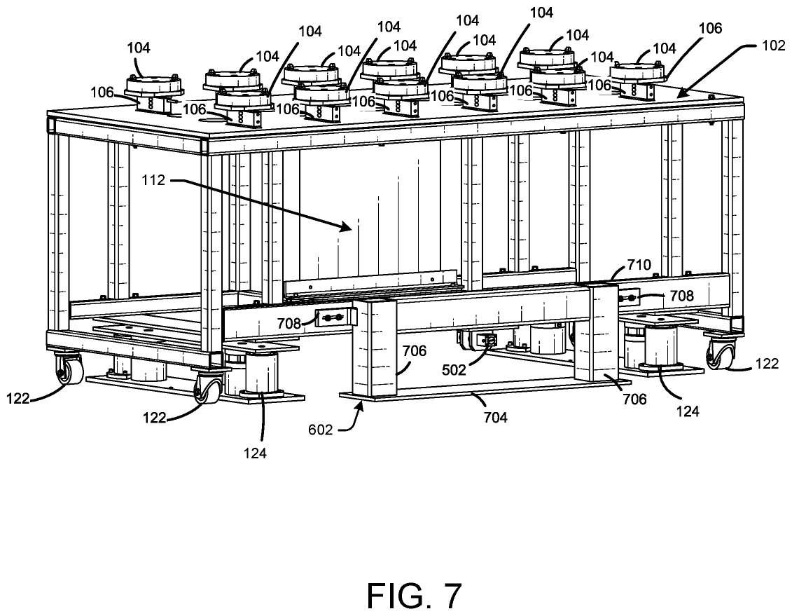

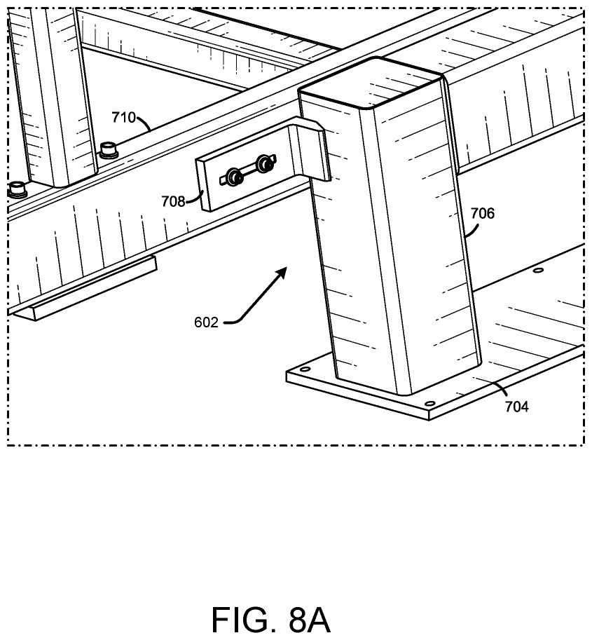

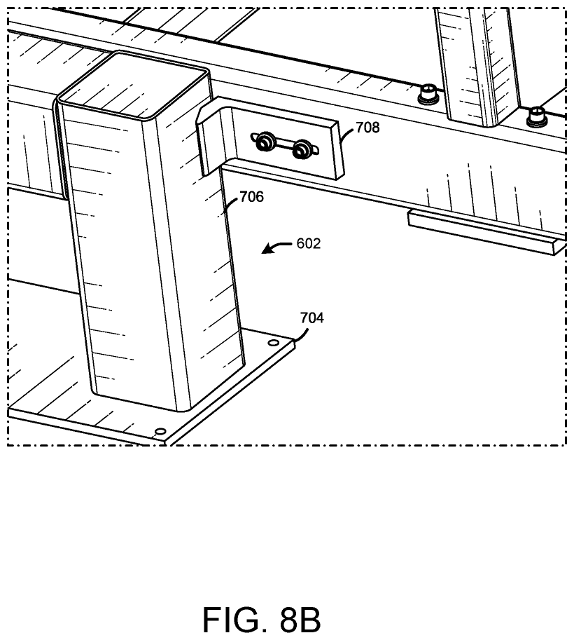

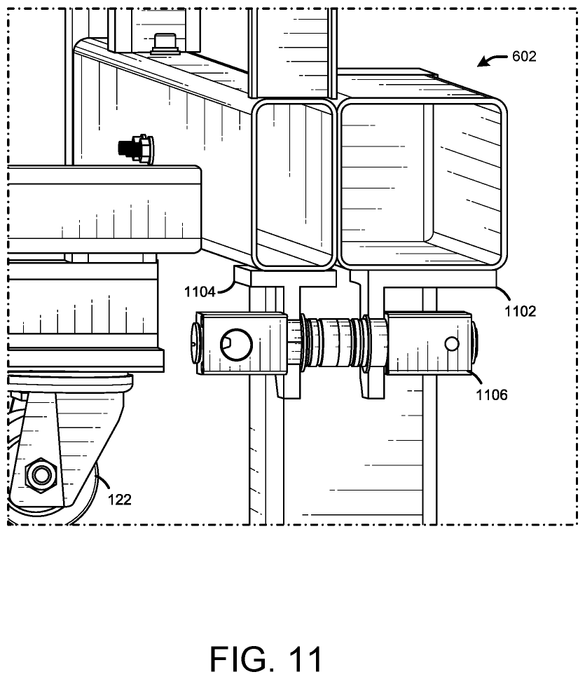

Referring to FIG. 6, two rows of the loading platforms 104 and the load cells 106 are shown, along with the electronic dock 112, the wheels 122, and the moveable components 124 (or lifts/jacks). The table 102 also may include a docking assembly 602 for docking the table 102. Details of the docking assembly are shown in FIG. 7, FIG. 8A, FIG. 8B, and FIG. 11.

FIG. 7 is a rear perspective view of the table 102 of the thermal spray system 100 of FIG. 1 in accordance with one embodiment of the present disclosure.

Referring to FIG. 7, the docking assembly 602 may include a base 704 to which legs 706 of the docking assembly 602 may connect. The legs 706 may connect to brackets 708 of the docking assembly 602, and the brackets 708 may connect to a beam 710 of the table 102 (e.g., via screws, pins, bolts or the like). In this manner, the table 102 may be docked and held securely in place by the docking assembly 602. Also, shown in FIG. 7, are the two rows of the loading platforms 104 and the load cells 106, along with the electronic dock 112, the wheels 122, the moveable components 124, and the electrical output 502.

FIG. 8A is a perspective view of a portion of the docking assembly 602 of FIG. 6 of FIG. 1 in accordance with one embodiment of the present disclosure.

FIG. 8B is a perspective view of a portion of the docking assembly 602 of FIG. 6 in accordance with one embodiment of the present disclosure.

Referring to FIG. 8A and FIG. 8B, the brackets 708 connect the legs 706 to the beam 710 of the table 102 to secure the table 102 for the coating and weighing process.

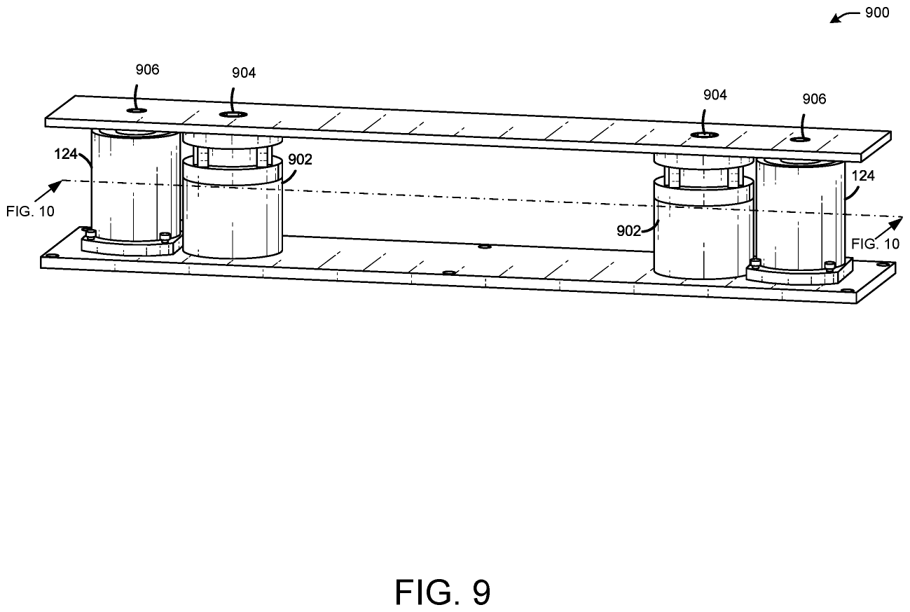

FIG. 9 is a perspective view of a portion 900 of the system 100 of FIG. 1 for setting the table in accordance with one embodiment of the present disclosure.

Referring to FIG. 9, pneumatic components 902 and the moveable components 124 of FIG. 1 may be used to support the table 102. Portions 904 and 906 (e.g., holes, voids, etc.)

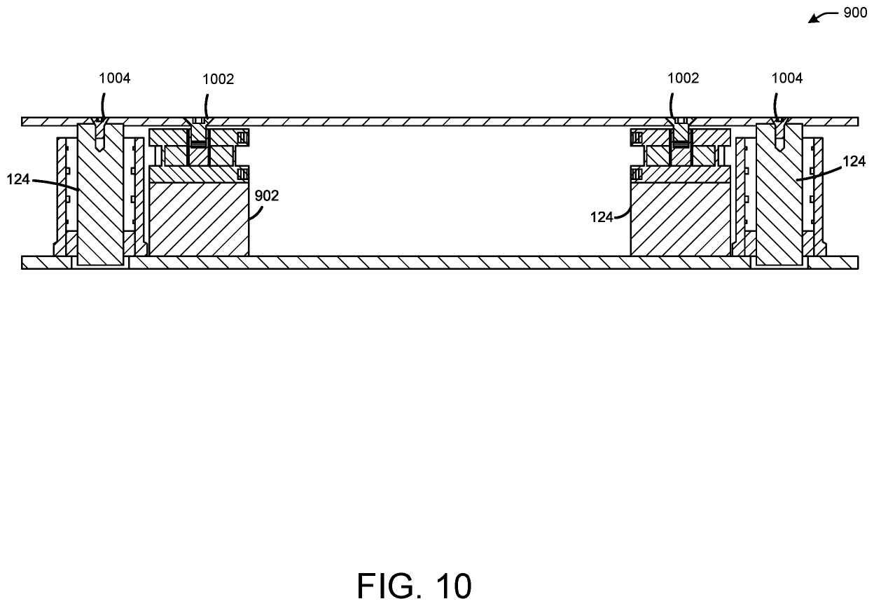

may allow for pins or bolts to push into the pneumatic components 902 and the moveable components 124, respectively, to secure the table 102 (e.g., as shown in FIG. 10).

FIG. 10 is a cross-section view of the portion 900 of FIG. 9 in accordance with one embodiment of the present disclosure.

Referring to the cross-section in FIG. 10, pins 1002 are shown is inserted into the pneumatic components 902, and pins 1004 are shown as inserted into the moveable components 124, securing the table 102 and allowing the table 102 to be lifted (e.g., to remove the pins 1002 and 1004) and moved.

FIG. 11 is a perspective view of the docking assembly 602 of FIG. 6 for docking the table of the system of FIG. 1 in accordance with one embodiment of the present disclosure.

Referring to FIG. 11, the docking assembly 602 may include a docking plate 1102 to connect to housing 1104 of the table 102, and may include a docking device 1106 to connect the docking plate 1102 to the housing 1104. For example, the docking device 1106 may include a socket and pin mating system that may connect and disconnect, allowing the docking plate 1102 of the table 102 to be attached to and detached from the docking device 1106 of the docking assembly 602.

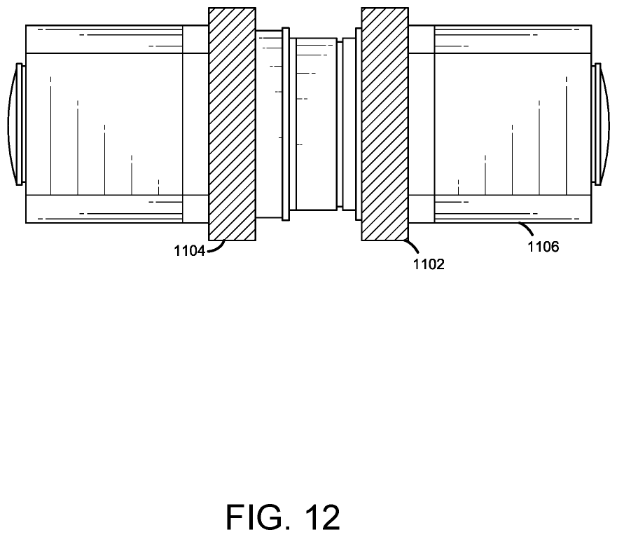

FIG. 12 is a side view of the docking device 1106 of FIG. 11 in accordance with one embodiment of the present disclosure.

As shown, the docking device 1106 may secure the housing 1104 of the table 102 to the docking plate 1102.

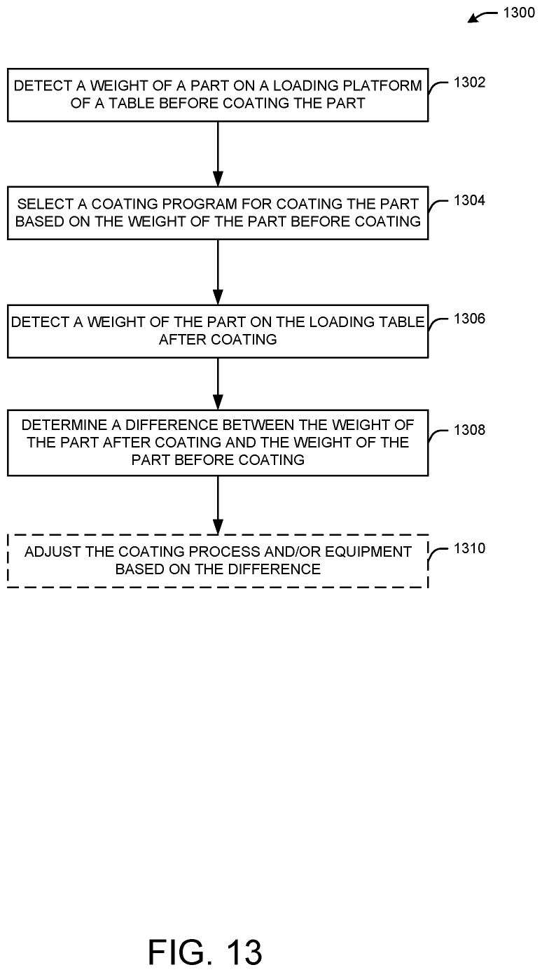

FIG. 13 is a flow diagram for a process 1300 of coating parts using the system of FIG. 1 in accordance with one embodiment of the present disclosure.

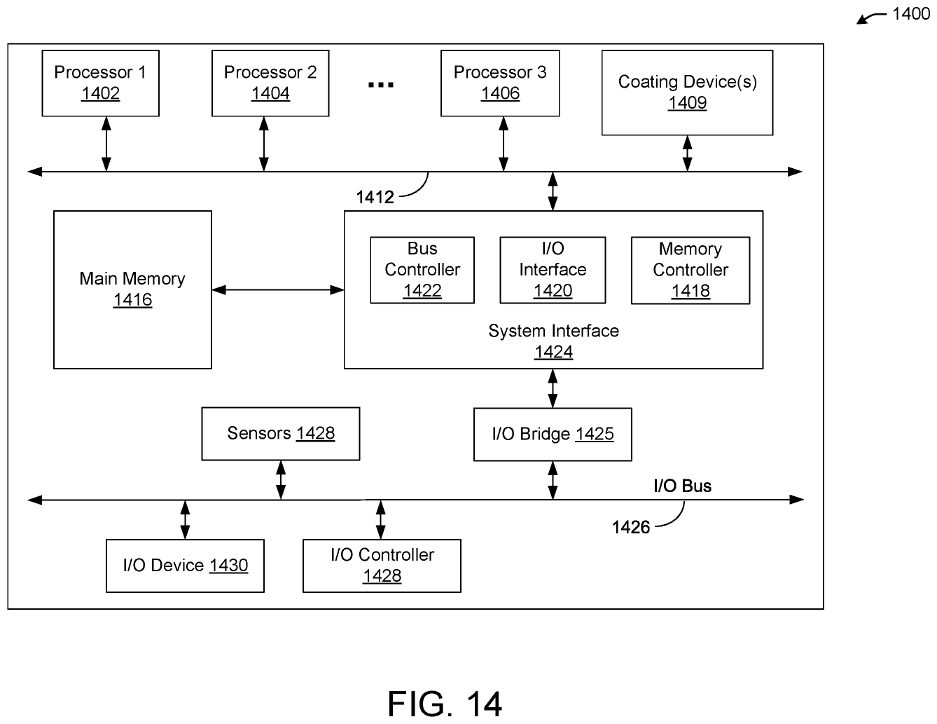

At block 1302, a device (or system, e.g., the processing circuitry of the electronic dock 112, as represented by the coating devices 1409 of FIG. 14) may detect a weight of a part (e.g., the part 108 of FIG. 1) on a loading platform (e.g., one of the loading platforms 104 of FIG. 1) of a table (e.g., the table 102 of FIG. 1) before coating the part 108. The weight may be detected based on a pneumatic force applied by the loading platform a load cell (e.g., one of the load cells 106 of FIG. 1), with the pneumatic force being caused by the weight of the part on the loading platform. The force may correspond to a weight (e.g., Force (lbs)=Pressure (psi)×Area (of platform)).

At block 1304, the device may select a coating program with which to coat the part based on the weight of the part before coating. The device may identify the part (e.g., based on a user input identifying the part, or automatically by identifying the weight and identifying part having that weight). Any part may have one or more coating programs that control the coating of the part (e.g., based on its weight, the number of parts being coated, etc.). The device may output the selected coating program and any related instructions (e.g., using the electrical output 502 of FIG. 5, to a device such as the robot 110 or any other devices used on the coating process).

At block 1306, after the part has been removed from the table, coated, and placed back onto the loading platform, the device may detect a weight of the part on the loading table (e.g., as described with respect to block 1302, but after the coating has been applied). The coating should add weight to the part, so the post-coating weight at block 1306 should represent an increase in weight with respect to the pre-coating weight at block 1302.

At block 1308, the device may determine a difference between the pre-coating weight of the part and the post-coating weight of the part (e.g., the difference between the weight at block 1306 and the weight at block 1302). The difference should correspond to an increased mass represented by the added weight of the coating material applied to the part. The increased mass may be known to the device based on the coating program (e.g., the device may be programmed with the weight of the coating applied based on the coating program for the given part). The device may assess whether this increased weight of the part represented by the coating is the expected weight (or within a range). If yes, the device may interpret that the coating was applied properly. In not, the device optionally may, at block 1310, adjust the coating process and/or any coating equipment parameters based on the difference, and may provide such information as outputs (e.g., using the electrical output 502) so that the coating process may be adjusted. In some embodiments, additional coating may be applied to the part, and when the part is placed back on the loading platform after additional coating, blocks 1306 and 1308 may repeat until the intended weight of the coating has been applied to the part and detected by the device.

These examples are not meant to be limiting.

FIG. 11 is a diagram illustrating an example machine 1400 that may be used in implementing embodiments of the present disclosure. For example, the machine 1400 of FIG. 14 may represent at least a portion of the system 100 shown in FIG. 1, as discussed above (e.g., the processing circuitry of the electrical dock 112 of FIG. 1 may be represented by at least a portion of the machine 1400, such as the coating devices 1409, and the robot 110 and any other coating equipment also may be represented at least partially by components of the machine 1400). The machine 1400 includes one or more processors 1402-1406. Processors 1402-1406 may include one or more internal levels of cache (not shown) and a bus controller 1416 or bus interface unit to direct interaction with the processor bus 1408. Processor bus 1408, also known as the host bus or the front side bus, may be used to couple the processors 1402-1406 with the system interface 1418. System interface 1418 may be connected to the processor bus 1408 to interface other components of the machine 1400 with the processor bus 1408. For example, system interface 1418 may include a memory controller 1412 for interfacing a main memory 1410 with the processor bus 1408. The main memory 1410 typically includes one or more memory cards and a control circuit (not shown). System interface 1418 may also include an input/output (I/O) I/O interface 1414 to interface one or more I/O bridges I/O bridge 1420 or I/O devices with the processor bus 1408. One or more I/O controllers and/or I/O devices may be connected with the I/O bus 1422, such as I/O controller 1424 and I/O device 1426, as illustrated. The machine 1400 may include sensors 1428 (e.g., implemented in the load cells 106 of FIG. 1, cable of performing pressure sensing to detect the pressure applied by a loading platform due to the weight of a part on the loading platform) to detect the weight of parts on the loading platforms 104.

I/O device 1426 may also include an input device (not shown), such as an alphanumeric input device, including alphanumeric and other keys for communicating information and/or command selections to the processors 1402-1406. Another type of user input device includes cursor control, such as a mouse, a trackball, or cursor direction keys for communicating direction information and command selections to the processors 1402-1406 and for controlling cursor movement on the display device.

Machine 1400 may include an adaptive storage device, referred to as main memory 1410, or a random access memory (RAM) or other computer-readable devices coupled to the processor bus 1408 for storing information and instructions to be executed by the processors 1402-1406. Main memory 1410 also may be used for storing temporary variables or other intermediate information during execution of instructions by the processors 1402-1406. Machine 1400 may include a read only memory (ROM) and/or other static storage device coupled to the processor bus 1408 for storing static information and instructions for the processors 1402-1406. The system outlined in FIG. 14 is but one possible example of a computer system that may employ or be configured in accordance with aspects of the present disclosure.

According to one embodiment, the above techniques may be performed by machine 1400 in response to processor 1404 executing one or more sequences of one or more instructions contained in main memory 1410. These instructions may be read into main memory 1410 from another machine-readable medium, such as a storage device. Execution of the sequences of instructions contained in main memory 1410 may cause processors 1402-1406 to perform the process steps described herein. In alternative embodiments, circuitry may be used in place of or in combination with the software instructions. Thus, embodiments of the present disclosure may include both hardware and software components.

A machine readable medium includes any mechanism for storing or transmitting information in a form (e.g., software, processing application) readable by a machine (e.g., a computer). Such media may take the form of, but is not limited to, non-volatile media and volatile media and may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory devices may include volatile memory (e.g., adaptive random access memory (DRAM), static random access memory (SRAM), etc.) and/or non-volatile memory (e.g., read-only memory (ROM), flash memory, etc.).

Computer program products containing mechanisms to effectuate the systems and methods in accordance with the presently described technology may reside in main memory 1410, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

Embodiments of the present disclosure include various steps, which are described in this specification. The steps may be performed by hardware components or may be embodied in machine-executable instructions, which may be used to cause a general-purpose or special-purpose processor programmed with the instructions to perform the steps. Alternatively, the steps may be performed by a combination of hardware, software and/or firmware.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations together with all equivalents thereof.

What is claimed is:

1. A table for assessing a coating of parts, the table comprising:
loading platforms on which parts are placed;
load cells connected to the loading platforms and configured to detect weights of the parts on the loading platforms; and
memory coupled to processing circuitry, wherein the processing circuitry is configured to:
select a coating program to be applied to a first part placed on a first loading platform of the loading platforms;
determine a pre-coating weight of the part on the first loading platform;
determine a post-coating weight of the part on the first loading platform; and
determine a difference between the pre-coating weight and the post-coating weight.

2. The table of claim 1, wherein the loading platforms and the load cells are arranged in two rows on the table.

3. The table of claim 1, wherein the loading platforms comprise twelve loading platforms, and wherein the load cells comprise twelve load cells.

4. The table of claim 3, wherein the processing circuitry is further configured to:
determine respective pre-coating weights of twelve parts placed on the twelve loading platforms; and
determine respective post-coating weights of the twelve parts placed on the twelve loading platforms.

5. The table of claim 1, further comprising an electrical output configured to output electrical signals comprising an indication of the coating program and the difference.

6. The table of claim 1, further comprising a docking assembly configured to secure the table.

7. The table of claim 1, wherein the loading platforms comprise pneumatic actuators.

8. A table for assessing a coating of parts, the table comprising:
loading platforms on which parts are placed;
load cells connected to the loading platforms and configured to detect weights of the parts on the loading platforms;
a docking assembly configured to secure the table; and
memory coupled to processing circuitry, wherein the processing circuitry is configured to:
select a coating program to be applied to a first part placed on a first loading platform of the loading platforms;
determine a pre-coating weight of the part on the first loading platform;
determine a post-coating weight of the part on the first loading platform; and
determine a difference between the pre-coating weight and the post-coating weight,
wherein the table is moveable using wheels attached to the table.

9. The table of claim 8, wherein the loading platforms and the load cells are arranged in two rows on the table.

10. The table of claim 8, wherein the loading platforms comprise two or more loading platforms, and wherein the load cells comprise two or more load cells.

11. The table of claim 10, wherein the processing circuitry is further configured to:
determine respective pre-coating weights of parts placed on the loading platforms; and
determine respective post-coating weights of the parts placed on the loading platforms.

12. The table of claim 8, further comprising an electrical output configured to output electrical signals comprising an indication of the coating program and the difference.

13. The table of claim 8, wherein the loading platforms comprise pneumatic actuators.

14. A system for assessing a coating of parts, the system comprising:
a table having loading platforms on which parts are placed;
load cells connected to the loading platforms and configured to detect weights of the parts on the loading platforms;
an electrical output; and
memory coupled to processing circuitry, wherein the processing circuitry is configured to:
select a coating program to be applied to a first part placed on a first loading platform of the loading platforms;
determine a pre-coating weight of the part on the first loading platform;
determine a post-coating weight of the part on the first loading platform; and
determine a difference between the pre-coating weight and the post-coating weight,
wherein the electrical output is configured to output electrical signals indicative of the coating program and the difference.

15. The system of claim 14, wherein the loading platforms and the load cells are arranged in two rows on the table.

16. The system of claim 14, wherein the loading platforms comprise two or more loading platforms, and wherein the load cells comprise two or more load cells.

17. The system of claim 16, wherein the processing circuitry is further configured to:
determine respective pre-coating weights of parts placed on the loading platforms; and
determine respective post-coating weights of the parts placed on the loading platforms.

18. The system of claim 14, further comprising a docking assembly configured to secure the table.

19. The system of claim 14, wherein the loading platforms comprise pneumatic actuators.

20. The system of claim 14, further comprising a second loading platform not connected to any load cell configured to detect a weight of any part placed on the second loading platform.
